(19) United States
(12) Patent Application Publication
(10) Pub. No.: US 2002/0046675 A1
(43) Pub. Date: Apr. 25, 2002

(54) Model train control system with remotely movable handles

(76) Inventor: Neil Young, Redwood City, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/947,211

(22) Filed: Sep. 4, 2001

Related U.S. Application Data
(60) Provisional application No. 60/230,625, filed on Sep. 5, 2000.

(51) Int. Cl. B60L 15/00

(52) U.S. Cl. 104/295

(57) ABSTRACT

A model vehicle control system in which a manually turnable speed controller, such as a potentiometer, is used. A motor is connected to the speed controller for turning it in response to a speed control signal. A control circuit provides a signal to the track to control a vehicle on the track. The motor is controlled by a remote control unit.

### CROSS-REFERENCE TO RELATED APPLICATIONS

This application claims the benefit of U.S. Provisional application Ser. No. 60/230,625, filed Sep. 5, 2000, which disclosure is incorporated herein by reference.

### BACKGROUND OF THE INVENTION

The present invention relates to model vehicle control systems, in particular train control systems. In particular, the invention relates to remotely controlling the speed of a train.

The traditional method for controlling the speed of a train is with a simple transformer which is wired to the train track. The train picks up its power from voltage on the electric track. The transformer has a handle which the user can turn to increase the speed of the train. This is typically done with a potentiometer inside the handle which varies a resistance to increase or decrease the voltage applied to the train track.

More modern train control systems incorporate remote controls and a multiplicity of control features. Examples of such systems using wireless remote controls are set forth in other patents of the same inventor, such as U.S. Pat. No. 5,441,223, U.S. Pat. No. 5,251,856, and U.S. Pat. No. 5,749,547.

In such systems, a remote control typically allows wireless transmission to a base unit connected to the train tracks. The commands from the remote are received by the base unit and converted into appropriate voltage modulation signals on the train track. Separately, a modernized version of a transformer, which itself is a command control unit, is separately connected to the train track to allow a user to control by manually moving handles or pressing buttons without the use of a remote.

In other technology areas, a remote control can be used to itself control a motorized potentiometer. Examples of the use of a motorized potentiometer could be found, for example, in U.S. Pat. Nos. 5,856,792 and 4,931,710. See also, U.S. Pat. No. 3,769,588.

One application of such motorized potentiometers is that a panel of potentiometers can be set to default or preset positions from a separate control panel. The control panel might set multiple potentiometers with the same signal, without requiring the user to physically turn each of the potentiometers to the desired value. In addition, such a control panel allows the possibility for initialization from a single user input.

One application of motorized potentiometers is the use of “flying faders”. Faders are used on musical equipment, such as sound mixers, etc. Often, a large number of knobs are provided, each attached to a separate potentiometer. A separate command input can be used to electronically set the different knobs to a desired value. This could be used for going to a saved preset condition, or to a default condition, for example.

In operation, such motorized potentiometers are actually moved to the desired position. The signal from the potentiometer then is used just as if a user had turned the potentiometer.

### SUMMARY OF THE INVENTION

The present invention provides a model vehicle control system in which a manually turnable speed controller, such as a potentiometer, is used. A motor is connected to the speed controller for turning it in response to a speed control signal. A control circuit provides a signal to the track to control a vehicle on the track. The motor is controlled by a remote control unit.

In one embodiment, the remote control unit sends a wireless signal to control the manually turnable speed controller. The manually turnable speed controller can be a potentiometer or a motorized potentiometer, combining the motor and potentiometer.

In a preferred embodiment, the remote control unit wirelessly transmits a signal to a base unit, which is connected to the train track. The base unit will control the train speed in response to the remote control unit. Separately, a command module connected to the track will detect the speed control signals remotely transmitted to the train. In response to this, it will cause the motor to turn the handle connected to the potentiometer, providing the user with visual feedback. This manually turning of a handle will generate a signal from the potentiometer connected to the handle. This signal is inhibited, however, so that it will not interfere with the signal already transmitted to the train. There is a potential for interference since the potentiometer must be manually turned, resulting in a time lag between the signal already applied to the train to control its speed and the movement of the potentiometer.

The present invention thus provides the advantage of allowing the control of a train remotely by a wireless remote unit, while also providing visual feedback to both the remote user and any user who may be at the command module actually attached to the tracks. This is accomplished in a way which provides a faster response time, by not going through the potentiometer attached to the handle, but rather going directly to the base unit in the train. Thus, the time required for the motor to actually turn the handle is eliminated. In addition, any interference between this turning of a handle at a later time and the earlier controlling of the train speed is eliminated by inhibiting the potentiometer signal so that it is not provided to the train track from the command unit.

For a further understanding of the nature and advantages of the invention, reference should be made to the following description taken in conjunction with the accompanying drawings.

### BRIEF DESCRIPTION OF THE DRAWINGS

FIG. 1 is a block diagram of the system using a remote unit according to one embodiment of the invention.

FIG. 2 is a block diagram of the circuitry inside the command unit of FIG. 1 for controlling handle movement and inhibiting the potentiometer output signal.

FIG. 3 is a flow chart illustrating the operation of one embodiment of the invention.

### DESCRIPTION OF THE SPECIFIC EMBODIMENTS

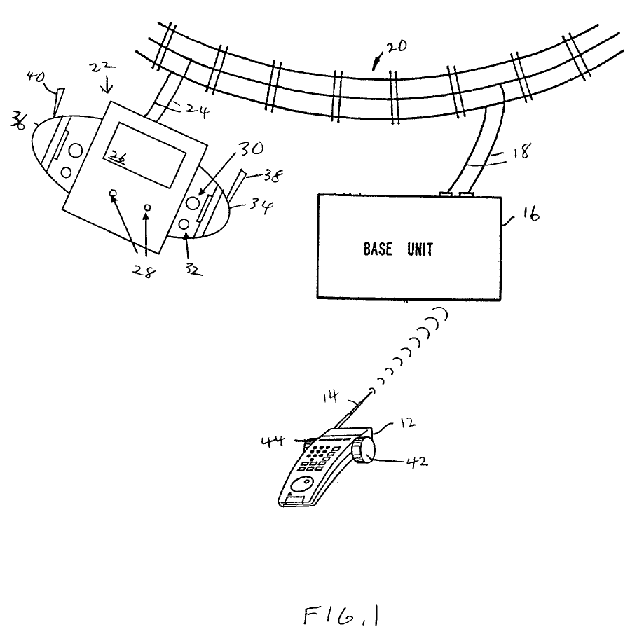

FIG. 1 illustrates a remote control unit 12 with an antenna 14 for wirelessly transmitting to a base unit 16. Base unit 16 is connected by wires 18 to train tracks 20.

Separately, a command unit 22 is also connected to train track 20 by wires 24. Control unit 22 includes a display 26 and ownership LEDs 28. It also contains a communication light 30 and a bell button 32. On the sides of the command unit are manually movable controllers 34 and 36, with associated handles 38 and 40. These controllers allow a user to move a train, with each controller being dedicated to a separate train on the track.

In an embodiment of the invention, speed control inputs 42 and 44 on remote control unit 12 are used to control the speed of the trains. This is accomplished by sending signals wirelessly to base unit 16. Base unit 16 will decode the signals, and convert them into an appropriate modulation of a signal applied to train tracks 20. More details on how this is accomplished are set forth in previous patents of the inventor, such as U.S. Pat. Nos. 5,251,856, 5,749,547 and 5,441,223, disclosures of which are hereby incorporated by reference.

While remote control unit 12 is directly controlling the speed of the train, command unit 22 is detecting this control signal via signals received on wires 24. In response to these detected signals, the command unit causes the appropriate handle 40 or 38 to move an appropriate amount, giving visual feedback to the user of the speed applied to the train. This also provides feedback to a separate user at the command unit that someone else is controlling the speed of one of the trains. When the train is out of sight for example, this user can tell from the movement of the handle that the other user is speeding up or slowing down his/her train.

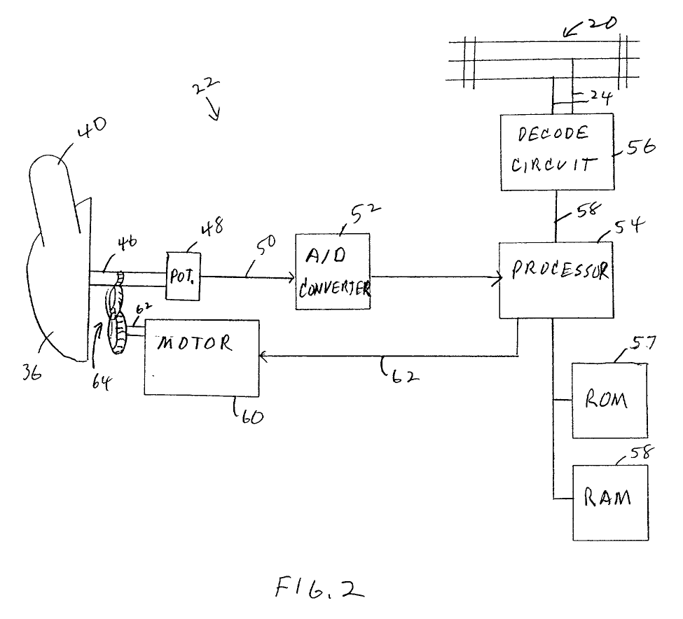

FIG. 2 is a block diagram of one embodiment of certain parts of command unit 22 of FIG. 1. Handle 40 and controller 36 are shown on the left of the diagram. Controller 36 is connected by a shaft 46 to a potentiometer 48. The potentiometer provides a variable resistance which modifies a voltage signal provided on a line 50 to an analog-to-digital (A/D) converter 52. A/D converter 52 provides a digital signal to a processor 54, indicating the desired speed. In normal operation with manual input, the processor 54 would then direct a decode circuit 56 to apply the signals via lines 24 to track 20.

In the present invention, decode circuit 56 detects that a modulation signal has been applied at track 20, and decodes the signal. The decoded signal is provided on line 58 to processor 54. Processor 54 operates in accordance with a program stored in a ROM 57, and also uses a RAM memory 58.

The processor, upon detecting a speed control signal has been applied to one of the trains, first determines if the train is the one corresponding to handle 40. If it is, a control signal will be sent to motor 60 on line 62. If the speed control signal was for the other train, the processor would send a signal to a separate motor for the other handle, not shown.

Motor 60 drives a shaft 62 connected to a gearing arrangement 64. This gearing arrangement drives shaft 46, causing controller 36 and handle 40 to turn.

Shaft 46, gearing arrangement 64, shaft 62, motor 60, and potentiometer 48 may be combined in a single unit which is called a motorized potentiometer, or motor pot. Similarly, separate ROM and RAM may not be necessary, but may be incorporated on the same semiconductor chip as processor 54.

When the processor causes motor 60 to turn handle 40, the turning of the handle will move potentiometer 48, causing a signal to be generated on line 50. This signal will then be provided to the processor through A/D converter 52. The processor will ignore this signal, and will not provide a control signal to the train track, since the processor will recognize that the signal from the potentiometer is a result of the control signal it just sent to the motor.

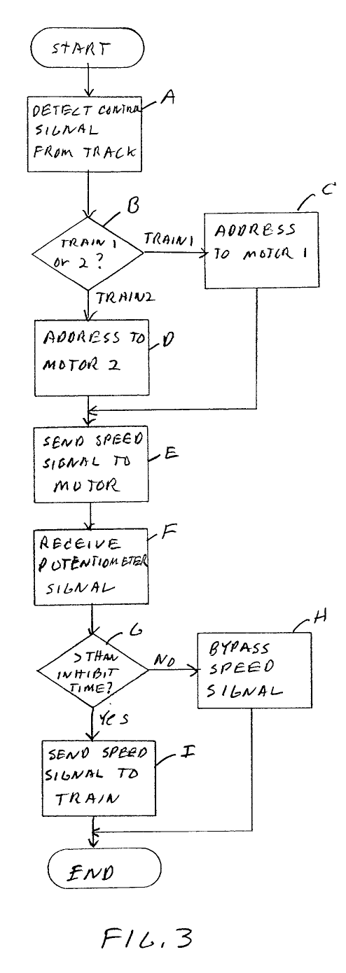

This operation of the processor is illustrated in FIG. 3, which shows a flowchart of the program used for this aspect of the processor's operation. First, the control signal from the track is detected (Step A). This control signal is examined to determine if it has a code for train 1 or train 2 (Step B). If this is train 1, the processor generates a signal that is addressed to the motor for motor 1 (Step C). Otherwise, the control signal is addressed to motor 2 (Step D). The processor then generates a speed signal to the motor corresponding to the detected speed from the track (Step E). The microprocessor then waits to detect a received potentiometer signal (Step F). This signal is then compared to a predetermined inhibit time (Step G). The inhibit time is set to be long enough to cover movement of the potentiometer initiated by the remote control unit. The inhibit time is short enough so that a subsequent movement manually by a user does not continue to be inhibited. For example, a time of one-half second - one second may be used.

If the inhibit time has not passed, the signal received from the potentiometer is ignored, and the step of sending a speed signal is bypassed (Step H). If, instead, the inhibit time has passed, the speed control signal is sent to the track in response to the potentiometer movement (Step I).

As will be understood by those of skill in the art, the present invention may be embodied in other forms without departing from the essential characteristics thereof. For example, the remote control signal could be sent directly to the command unit, rather than being picked up from the track. In an alternate embodiment, the remote control signal could be used to move the handle directly, with the potentiometer signal then being used to control the train. This will not provide as fast a response, but will still provide the visual feedback. Alternately, instead of a wireless remote unit, a wired unit could be used to send the remote signals. Accordingly, the foregoing description is intended to be illustrative, but not limiting, of the scope of the invention which is set forth in the following claims.

What is claimed is:

1. A model vehicle control system comprising:
a remote control unit for generating a remote control signal;
a manually turnable controller;
a motor connected to said manually turnable controller for turning said manually turnable controller in response to said remote control signal; and
a control circuit connected to a track for providing a vehicle control signal to said vehicle in response to said remote control signal.

2. The system of claim 1 wherein said manually turnable controller comprises a speed control potentiometer.

3. The system of claim 1 further comprising:
means for inhibiting a manually turnable controller output signal resulting from the movement of said manually turnable controller by said motor.

4. The system of claim 1 wherein said remote control signal is transmitted wirelessly by said remote control unit.

5. The system of claim 1 further comprising a user movable handle connected to said manually movable controller, said handle moving when said motor moves said manually movable controller.

6. The system of claim 1 wherein said remote control unit further comprises:
a speed control input,
a circuit for generating a speed control signal in response to said speed control input, and
a wireless transmitter.

7. The system of claim 6 wherein said control circuit is mounted in a base unit connected to said track, said base unit further comprising:
a receiver for receiving said speed control signal, and
said control circuit converting said speed control signal into a modulation of a power signal applied to said track.

8. The system of claim 7 wherein said controller is connected to said track and further comprises:
a control receiver connected to said track for detecting modulations of said power signal applied to said track,
a processor coupled to said control receiver for detecting a detected speed control signal from said modulations,
said manually movable controller including a potentiometer having a potentiometer output for providing a speed control signal;
a digital to analog converter coupled between said potentiometer and said processor for providing a digital speed control signal to said processor;
a motor control circuit connected to said motor,
a memory connected to said processor, said memory including a program for directing said processor to send control signals to said motor control circuit responsive to said detected speed control signal, and further for preventing said digital speed control signal from being applied as a control to said railroad track when said digital speed control signal results from movement of said potentiometer by said motor.

9. The system of claim 1 wherein said vehicle is a train.

10. A model train control system comprising:
(a) a remote control unit having
a speed control input,
a circuit for generating a speed control signal in response to said speed control input, and
a wireless transmitter;
(b) a base unit connected to a railroad track and having
a receiver for receiving said speed control signal, and
a circuit for converting said speed control signal into a modulation of a power signal applied to said train track;
(c) a control transmitter connected to said train track and having
a control receiver connected to said track for detecting modulations of said power signal applied to said track,
a processor coupled to said control receiver for detecting a detected speed control signal from said modulations,
a speed control potentiometer having a potentiometer output for providing a speed control signal;
a digital to analog converter coupled between said speed control potentiometer and said processor for providing a digital speed control signal to said processor;
a motor connected to said potentiometer,
a motor control circuit connected to said motor,
a memory connected to said processor, said memory including a program for directing said processor to send control signals to said motor control circuit responsive to said detected speed control signal, and further for preventing said digital speed control signal from being applied as a control to said railroad track when said digital speed control signal results from movement of said potentiometer by said motor.

11. A method for controlling a model vehicle comprising:
generating a control signal;
turning a manually turnable controller in response to said control signal; and
providing a signal to said vehicle in response to said control signal.

12. The method of claim 11 further comprising:
providing said signal to said vehicle independent of said manually turnable controller; and
inhibiting a signal from said manually turnable controller.
